(19) United States
(12) Patent Application Publication
(10) Pub. No.: US 2012/0227762 A1
(43) Pub. Date: Sep. 13, 2012

(54) PLASMA ASHING COMPOUNDS AND METHODS OF USE

(75) Inventors: Christian Dussarrat, Wilmington, DE (US); Rahul Gupta, Newark, DE (US); Vincent M. Omarjee, Grenoble (FR); Nathan Stafford, Damascus, OR (US)

(73) Assignee: American Air Liquide, Inc., Fremont, CA (US)

(21) Appl. No.: 13/502,057

(22) PCT Filed: Oct. 14, 2010
(86) PCT No.: PCT/US10/52711

§ 371 Date: May 23, 2012

Related U.S. Application Data
(60) Provisional application No. 61/251,571, filed on Oct. 14, 2009.

(51) Int. Cl. B08B 7/00

(52) U.S. Cl. 134/1.1

(57) ABSTRACT

Disclosed are compounds for plasma ashing photoresist layers on a substrate and methods of using the same. The plasma ashing compounds induce limited to no damage to the underlying layer, such as the low-k film layer.

### CROSS-REFERENCE TO RELATED APPLICATIONS

This application claims the benefit under 35 U.S.C. §119(e) to provisional application No. 61/251,571, filed Oct. 14, 2009, the entire contents of which are incorporated herein by reference.

### TECHNICAL FIELD

Disclosed are compounds for plasma ashing the photoresist layer on a substrate and plasma ashing methods of using the same. The plasma ashing compounds induce minimal to no damage to the underlying substrate, such as low-k films.

### BACKGROUND

In the semiconductor and photovoltaic industries, the plasma ashing process removes the photoresist layer from an etched wafer. Traditionally, a plasma source generates reactive species from a gas source (such as a hydrogen-, oxygen-, or fluorine-containing gas). See, e.g., US Pat. App. Pub. No. 2001/0005632 and 2009/0197422. The reactive species then react with the photoresist layer forming volatile species. The volatile species formed are removed by low pressure in the reactor, which is maintained by a vacuum pump.

To reduce the interline capacitance of interconnections in new generations of devices (for instance beyond 65 nm node), porous low-k films such as SiCOH are introduced as dielectric materials. However, the porosity of these films increases the difficulty of the photoresist (PR) stripping and descum operations. Indeed, the plasma used to remove the PR layer, by breaking its C—C bonds and producing volatile by-products, also tend to modify the underlying porous low-k layer. The porosity of the low-k layer facilitates diffusion of active plasma species through the low-k layer resulting in degradation of its electrical and mechanical performances.

Consequently, less damaging photoresist compounds for use in plasma applications are needed.

### SUMMARY

Disclosed are methods of plasma ashing a photoresist layer deposited on a substrate. A substrate having a low-k layer and photoresist layer thereon is disposed in a reactor. A vapor of an oxygen-containing molecule is introduced into the reactor. In one embodiment, the oxygen-containing molecule is selected from the group consisting of ethers having the formula R¹—O—R²; esters having the formula R³—C(═O)—O—R⁴; alpha-hydroxy ethers having the formula R³—CH(—OH)—O—R⁴; alpha-alkoxy ethers having the formula R³—CH(—OR⁴)—O—R⁵; alpha-amino ethers having the formula R³—CH(—NR⁴)—O—R⁵; anhydrides having the formula R³—C(═O)—O—C—(═O)—R⁴; and combinations thereof; wherein each R¹ and R² is independently selected from an alkyl group having 1 to 6 carbon atoms and each R³, R⁴, and R⁵ is independently selected from hydrogen or an alkyl group having 1 to 6 carbon atoms. In a second embodiment, the oxygen-containing molecule has the formula R¹—O—R², wherein each R¹ and R² is independently selected from an alkyl group having 1 to 6 carbon atoms and R¹ and R² may be bridged. The vapor is activated with plasma to produce a plasma activated vapor. The photoresist layer reacts with the plasma activated vapor. The disclosed methods may include one or more of the following aspects:

the activating step occurring before the introducing step;

the plasma having a power ranging from approximately 50 W to approximately 800 W;

the vapor further comprising O₂, CO₂, H₂, H₂S, SO₂, COS, CS₂, CH₄, hydrofluorocarbons, NH₃, N₂, NO, NOₓ, He, and combinations thereof;

the vapor further comprising H₂ or O₂;

the low-k layer comprising carbon;

the low-k layer having a dielectric constant ranging from 1.7 to 3.9;

the low-k layer having a dielectric constant ranging from 2.2 to 2.8;

the low-k layer being porous;

the oxygen-containing gas being ethyl acetate;

the oxygen-containing gas being dimethyl ether or ethylmethyl ether; and

the oxygen-containing compound being dimethyl ether, ethylmethyl ether, or ethylene oxide.

Also disclosed are methods of plasma ashing a photoresist layer deposited on a substrate similar to the method above. However, instead of introducing the oxygen-containing gas into the reactor, the vapor of a mixture of CO₂ and a sulfur-containing gas selected from the group consisting of H₂S, CS₂, and mixtures thereof is introduced into the reactor. As before, the vapor is activated with plasma to produce a plasma activated vapor and the photoresist layer reacts with the plasma activated vapor. Preferably, a mixture of CO₂ and CS₂ is introduced into the reactor.

### BRIEF DESCRIPTION OF THE DRAWINGS

For a further understanding of the nature and objects of the present invention, reference should be made to the following detailed description, taken in conjunction with the accompanying drawings, in which like elements are given the same or analogous reference numbers and wherein:

FIG. 1 is a graph comparing the change in dielectric constant of SiCOH low-k films as a function of the photoresist ashing rate for oxygen, an ethyl acetate/oxygen mixture, and an ethylene oxide/oxygen mixture under same process conditions.

FIG. 2 is a graph showing the Auger depth profile of carbon in SiCOH low-k films before and after photoresist ashing with oxygen, an ethyl acetate/oxygen mixture, and an ethylene oxide/oxygen mixture.

### DESCRIPTION OF PREFERRED EMBODIMENTS

Disclosed are compounds for plasma ashing photoresist layers on substrates and methods of using the same. The plasma ashing compounds induce little to no damage to the underlying layer, such as the low-k film layer.

The disclosed compounds may be oxygen-containing molecules selected from the group consisting of ethers having the formula R¹—O—R²; esters having the formula R³—C(═O)—O—R⁴; alpha-hydroxy ethers having the formula R³—CH(—OH)—O—R⁴; alpha-alkoxy ethers having the formula R³—CH(—OR⁴)—O—R⁵; alpha-amino ethers having the formula R³—CH(—NR⁴)—O—R⁵; anhydrides having the formula R³—C(═O)—O—C—(═O)—R⁴; and combinations thereof; wherein each R¹ and R² is independently selected from an alkyl group having 1 to 6 carbon atoms, preferably having 1 to 2 carbon atoms, and each R³, R⁴, and R⁵ is independently selected from hydrogen or an alkyl group having 1 to 6 carbon atoms, preferably having 1 to 2 carbon atoms. Alternatively, the oxygen-containing molecule may have the formula R¹—O—R², wherein each R¹ and R² is independently selected from an alkyl group having 1 to 6 carbon atoms and R¹ and R² may be bridged.

The disclosed oxygen-containing compounds are suitable for photoresist ashing and compatible with the current generation of low-k films (65 nm and lower), and are expected to be compatible with future generations of low-k films, because they induce little to no damage on the low-k substrate. In order to achieve those properties, Applicants believe that the C and/or N atoms contained in the compounds help reduce the direct impact of the oxygen radicals during the ashing process. Preferably, the oxygen-containing compound is both suitably volatile and stable during the ashing process for delivery into the reactor/chamber.

Examples of the oxygen-containing compounds include dimethyl ether, ethyl methyl ether, ethyl acetate, isopropyl acetate, ethylene oxide, and propylene oxide. Preferably the oxygen-containing compound is ethyl acetate or ethylene oxide. The compounds are high purity chemicals, preferably having purity levels of 99.99% to 99.9999%. The exemplary oxygen-containing compounds are commercially available.

Alternatively, the disclosed compounds may be a mixture of sulfur-containing molecules selected from the group consisting of H₂S, CS₂, and mixtures thereof, preferably CS₂, and a second gas being CO₂. The volumetric ratios of the mixtures may range from 10:1 to 1:10, preferably 5:1 to 1:5, more preferably 1:1.

The disclosed compounds may be used to plasma ash the photoresist layer on a substrate. The disclosed plasma ashing method may be useful in the manufacture of semiconductor, photovoltaic, LCD-TFT, or flat panel type devices. The disclosed compounds may be used at high temperature to remove as much of the photoresist layer as possible (i.e., stripping) and at lower temperatures to remove the photoresist residuals in the trenches (i.e., the “descum” process).

The plasma ashing method includes providing a reactor having a substrate disposed therein, the substrate having a low-k layer and a photoresist layer thereon. Vapors of the disclosed compounds are introduced into the reactor. The vapors are activated by plasma. The photoresist layer and the plasma activated vapors react to form volatile species that are removed from the reactor.

The reactor may be any enclosure or chamber within a device in which ashing methods take place such as, and without limitation, Reactive Ion Etching (RIE), Inductively Coupled Plasma (ICP), or Microwave Plasma reactors, or other types of ashing systems capable of removing the photoresist layer or generating active species. Suitable commercially available reactors include but are not limited to the Applied Materials magnetically enhanced reactive ion etcher sold under the trademark eMAX™ or the Novellus microwave stripper sold under the trademark PEP IRIDIA™ or the Mattson Plasma stripper sold under the trademark Suprema™.

The reactor may contain one or more than one substrate. For example, the reactor may contain from 1 to 200 silicon wafers having from 25.4 mm to 450 mm diameters. The one or more substrates may be any suitable substrate used in semiconductor, photovoltaic, flat panel or LCD-TFT device manufacturing. Examples of suitable substrates include without limitation silicon substrates, silica substrates, silicon nitride substrates, silicon oxy nitride substrates, tungsten substrates, titanium nitride, tantalum nitride, or combinations thereof. Additionally, substrates comprising tungsten or noble metals (e.g. platinum, palladium, rhodium or gold) may be used.

The substrate contains one or more layers of differing materials already deposited upon it from a previous manufacturing step. At a minimum, the substrate contains a low-k layer and a photoresist layer. The low-k layer may include Si, C, O, H, or combinations thereof. Preferably, the low-k layer includes at least C. The low-k layer may be porous. Alternatively, the low-k layer may comprise boron based films, such as BCN, or methyl silsesquioxane (MSSQ).

A TiN layer may optionally be deposited on the low-k layer. The optional TiN layer may be used to protect the surface of the low-k layer from damage resulting from low-k etching and photoresist ashing. The optional TiN layer may also be used to maintain critical dimensions of vias patterned in the low-k layer.

A Bottom Anti-Reflective Coating (BARC) layer may optionally be deposited on the low-k layer and/or on the TiN layer. The optional BARC layer reduces light reflectance during lithography and reduces variation in patterned critical dimensions.

The top layer on each substrate is a photoresist layer. The photoresist layer may be located directly on the low-k layer, on the optional TiN layer, or on the optional BARC layer.

The photoresist layer may be deposited by spin coating. Any commercially available or subsequently developed photoresist materials may be used to deposit the photoresist layer. Exemplary commercially available photoresist materials include but are limited to the Dow Electronic Materials photoresists sold under the trademark EPIC™; the 193 nm, 248 nm, iLine, or Thick Film series of photoresists by AZ Electronic Materials; or the Negative or Positive photoresists by Futurrex, Inc.

After deposition of the photoresist layer, a photomask and radiation, such as UV, ion beam, or a mercury lamp, may be used to pattern the photoresist layer. The radiation reacts with the exposed portions of the photoresist layer, altering its chemical state. A developer is then used to either remove the altered photoresist layer (a positive resist) or to remove the non-altered photoresist layer (a negative resist). The underlying layers (the low-k layer and the optional TiN and BARC layers) are then subsequently plasma etched to transfer the pattern from photoresist layer.

Once the desired pattern has been etched, the photoresist layer may be removed by the disclosed plasma ashing processes. The BARC layer may also be removed by the disclosed plasma ashing processes. Typically, removal of the TiN layer requires different plasma chemistries (such as CF₄ and Ar) than the disclosed compounds.

The low-k etching and plasma ashing processes may take place in the same reactor, such as those described previously. Preferably, one reactor may be used for both. However, one of ordinary skill in the art will recognize that situations may arise in which two separate reactors are necessary. For example, it may be important to prevent reactor fluorine contamination from TiN chemistry affecting the plasma ashing processes.

The disclosed compounds are introduced into the reactor in vapor form. The disclosed compounds may be in gas form and therefore directly introduced into the reactor. Alternatively, the disclosed compounds may be in liquid or solid form. The liquid or solid compounds may be supplied either in neat form or in a blend with a suitable solvent, such as supercritical CO₂, ethyl acetate, isopropyl acetate, dimethyl ether, methyl ethyl ether, ethylene oxide, propylene oxide, and mixtures thereof. The liquid or solid compounds may be present in varying concentrations in the solvent.

To introduce the liquid or solid compounds into the reactor in vapor form, the neat or blended compounds may be vaporized by a conventional vaporization step such as direct vaporization or by bubbling. The neat or blended compounds may be fed in liquid state to a vaporizer where it is vaporized before introduction into the reactor. Alternatively, the neat or blended compounds may be vaporized by passing a carrier gas into a container containing the neat or blended compounds or by bubbling the carrier gas into the neat or blended compounds. The carrier gas may include, but is not limited to, Ar, He, N₂, and mixtures thereof. The carrier gas and disclosed compounds are then introduced into the reactor as a vapor.

If necessary, the container containing the disclosed compounds may be heated to a temperature that permits the compounds to be in liquid phase and to have a sufficient vapor pressure. The container may be maintained at temperatures in the range of, for example, approximately 0° C. to approximately 150° C. Those skilled in the art recognize that the temperature of the container may be adjusted in a known manner to control the amount of compound vaporized.

The disclosed vapors may be mixed with other gases either prior to introduction into the reactor or inside the reactor. Exemplary volumetric ratios of the mixtures range from 10:1 to 1:10, preferably 5:1 to 1:5, more preferably 1:1. Exemplary gases include, without limitation, O₂, CO₂, H₂, H₂S, SO₂, COS, CS₂, CH₄, hydrofluorocarbons, NH₃, N₂, He, and combinations thereof. Preferably the disclosed compounds are mixed with H₂ or O₂.

The vapors of the disclosed compounds and any of the optional gases may be activated by plasma to produce a plasma activated vapor. The plasma decomposes the vapors into radical form. The plasma may be generated with a power ranging from about 50 W to about 800 W, preferably from about 100 W to about 200 W. However, one of ordinary skill in the art will recognize that the plasma power is directly related to tool design and may differ from the disclosed ranges herein. The plasma may be generated or present within the reactor itself. Alternatively, the plasma may generally be at a location removed from the reactor, for instance, in a remotely located plasma system. One of skill in the art will recognize methods and apparatus suitable for such plasma treatment.

Use of a remote plasma system allows a mixture of molecules and radicals to be introduced into the reactor. The ions typically remain trapped in the remote plasma source, thereby preventing any damage to the substrate. This embodiment may be beneficial for sensitive low-k films. When ion damage is not as much of a concern, direct plasma may be faster and conducted at lower temperature.

The temperature and the pressure within the reactor are held at conditions suitable for the photoresist layer to react with the plasma activated vapor. For instance, the pressure in the reactor may be held between about 0.1 mTorr and about 1000 Torr, preferably between about 10 mTorr and 1 Torr, and more preferably between about 100 mTorr and 500 mTorr, as required per the ashing parameters. Likewise, the temperature of the substrate may be held between about −30° C. and about 400° C., preferably between about −30° C. and about 120° C., and more preferably between about 25° C. and about 50° C. When a remote plasma source is used, the temperature may range from approximately 100° C. to approximately 400° C., preferably approximately 250° C. to approximately 350° C.

The reactions between the photoresist layer and the plasma activated vapor results in removal of the photoresist layer from the substrate. The removal results from a physical sputtering of photoresist layer from plasma ions, molecules, and radicals (accelerated by the plasma) and also by chemical reaction of plasma species to convert the photoresist (PR) layer to CO₂ and H₂O(C, H and O from the PR recombines with H or O species from the plasma).

The ashing step may be preceded and/or followed by a wet cleaning step where an aqueous solution (water or halogenated solvents) removes the residues left after plasma etch/ash processes. For example, wet cleaning may remove a large portion of the photoresist layer followed by use of the disclosed plasma ashing processes for descum operations. Alternatively, the disclosed plasma ashing processes may be used to strip the photoresist layer followed by a wet cleaning step to remove any traces of residue.

The disclosed ashing processes minimize damage to the low-k layer. Applicants have determined by gas analysis that the disclosed compounds introduce higher hydrogen content into the plasma as compared to O₂ plasma ash processes. Applicants believe that higher oxygen concentration may be more damaging than higher concentrations of hydrogen. As a result, the disclosed processes minimize damage to the low-k layer.

Applicants believe that the disclosed O-containing and S-containing compounds will provide protection through polymer formation on the low-k surface. Applicants believe that the optimized plasma ash processes using conventional plasma ashing reactors will result in an increase in the dielectric constant of the low-k layer of less than approximately 20%, preferably less than 5%.

### Example

The following non-limiting example is provided to further illustrate embodiments of the invention. However, the example is not intended to be all inclusive and is not intended to limit the scope of the inventions described herein.

### Example

The damage to low-k films resulting from the disclosed plasma ashing processes using an approximate 1:1 ratio of ethyl acetate and oxygen and an approximate 1:1 ratio of ethylene oxide and oxygen is compared to an O₂ plasma ashing process. These are preliminary test results and are expected to improve on commercial ashing tools.

The testing was performed on planar low-k films and planar photoresist films. A porous low-k layer containing Si, C, O and H was grown in a P5000 PECVD reactor. The layer was ˜180 nm thick and with a dielectric constant of ˜2.5. The dielectric property was measured by Hg probe dielectric measurement tool from MDC. The planar resist layer was deposited by spinning AZP4210 resist in a cleanroom environment.

The plasma ashing reactor was a custom designed parallel plate capacitively coupled chamber where the RF source was applied to the top electrode and the bottom electrode was kept grounded. The RF source was 13.56 MHz power supply. Power was varied from 100 W to 300 W. Pressure was varied from 200 mTorr to 600 mTorr. Flow rates were varied between 20 sccm and 100 sccm. The process was conducted at approximately temperature (ranging from approximately 22° C. to approximately 28° C.).

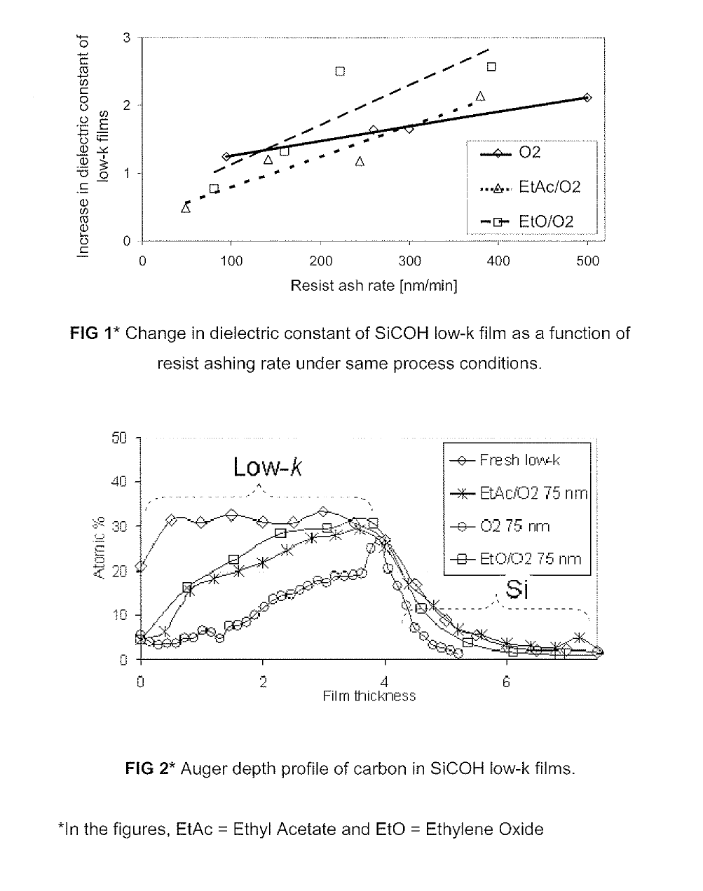

FIG. 1 is a graph comparing the change in dielectric constant of SiCOH low-k films as a function of the photoresist ashing rate for oxygen, an ethyl acetate/oxygen mixture, and an ethylene oxide/oxygen mixture under same process conditions. The low-k damage time was varied to keep the equivalent resist removal of 75 nm. At lower ashing rates, both the ethyl acetate/O₂ and ethylene oxide/O₂ mixtures show improvement over pure O₂, resulting in less change in dielectric constant.

FIG. 2 is a graph showing the Auger depth profile of carbon in SiCOH low-k films before and after photoresist ashing with oxygen, an ethyl acetate/oxygen mixture, and an ethylene oxide/oxygen mixture. This graph illustrates the loss of carbon in low-k damaged films in the ashing chamber. The carbon depth profile was obtained by sputtering the film in high vacuum and measuring the surface characteristics using an Auger spectroscopy instrument. The ashing time for damage was kept equivalent to resist removal of 75 nm. Higher loss of carbon content (i.e., lower atomic %) indicates that the low-k film is damaged. The ethyl acetate/O₂ and ethylene oxide/O₂ mixtures show less carbon loss than pure O₂.

Preferred processes and apparatus for practicing the present invention have been described. It will be understood and readily apparent to the skilled artisan that many changes and modifications may be made to the above-described embodiments without departing from the spirit and the scope of the present invention. The foregoing is illustrative only and that other embodiments of the integrated processes and apparatus may be employed without departing from the true scope of the invention defined in the following claims.

1. A method of plasma ashing a photoresist layer deposited on a substrate, the method comprising:
Providing a reactor having a substrate disposed therein, the substrate having a low-k layer and photoresist layer thereon;
Introducing into the reactor a vapor of an oxygen-containing molecule selected from the group consisting of ethers having the formula R¹—O—R²; esters having the formula R³—C(═O)—O—R⁴; alpha-hydroxy ethers having the formula R³—CH(—OH)—O—R⁴; alpha-alkoxy ethers having the formula R³—CH(—OR⁴)—O—R⁵; alpha-amino ethers having the formula R³—CH(—NR⁴)—O—R⁵; anhydrides having the formula R³—C(═O)—O—C—(═O)—R⁴; and combinations thereof; wherein each R¹ and R² is independently selected from an alkyl group having 1 to 6 carbon atoms and each R³, R⁴, and R⁵ is independently selected from hydrogen or an alkyl group having 1 to 6 carbon atoms;
Activating the vapor with plasma to produce a plasma activated vapor;
Reacting the photoresist layer with the plasma activated vapor.

2. The method of claim 1, wherein the activating step occurs before the introducing step.

3. The method of claim 1, wherein the plasma has a power ranging from approximately 50 W to approximately 800 W.

4. The method of claim 1, wherein the vapor further comprises O₂, CO₂, H₂, H₂S, SO₂, COS, CS₂, CH₄, hydrofluorocarbons, NH₃, N₂, NO, NOₓ, He, and combinations thereof.

5. The method of claim 1, wherein the low-k layer comprises carbon and has a dielectric constant ranging from 1.7 to 3.9.

6. The method of claim 1, wherein the low-k layer is porous.

7. The method of claim 1, wherein the oxygen-containing gas is ethyl acetate.

8. The method of claim 1, wherein the oxygen-containing gas is dimethyl ether or ethylmethyl ether.

9. A method of plasma ashing a photoresist layer deposited on a substrate, the method comprising:
Providing a reactor having a substrate disposed therein, the substrate having a low-k layer and a photoresist layer thereon;
Introducing into the reactor a vapor comprising a mixture of (a) a sulfur containing gas selected from the group consisting of H₂S, CS₂, and mixtures thereof, and (b) a second gas being CO₂;
Activating the vapor with plasma to produce a plasma activated vapor;
Reacting the photoresist layer with the plasma activated vapor.

10. The method of claim 9, wherein the activating step occurs before the introducing step.

11. The method of claim 9, wherein the plasma has a power ranging from approximately 50 W to approximately 800 W.

12. The method of claim 9, wherein the vapor further comprises H₂, O₂, SO₂, COS, CH₄, hydrofluorocarbons, NH₃, N₂, He, and combinations thereof.

13. The method of claim 9, wherein the low-k layer comprises carbon and has a dielectric constant ranging from 1.7 to 3.9.

14. The method of claim 9, wherein the low-k layer is porous.

15. A method of plasma ashing a photoresist layer deposited on a substrate, the method comprising:
Providing a reactor having a substrate disposed therein, the substrate having a SiCOH low-k layer and photoresist layer thereon;
Introducing into the reactor a vapor of an oxygen-containing molecule having the formula R¹—O—R², wherein each R¹ and R² is independently selected from an alkyl group having 1 to 6 carbon atoms and R¹ and R² may be bridged;
Activating the vapor with plasma to produce a plasma activated vapor;
Reacting the photoresist layer with the plasma activated vapor.

16. The method of claim 15, wherein the oxygen-containing compound is dimethyl ether, ethylmethyl ether, or ethylene oxide.

17. The method of claim 15, wherein the vapor further comprises O₂, CO₂, H₂, H₂S, SO₂, COS, CS₂, CH₄, hydrofluorocarbons, NH₃, N₂, He, and combinations thereof.
